(19) United States
(12) Patent Application Publication
(10) Pub. No.: US 2011/0209324 A1
(43) Pub. Date: Sep. 1, 2011

(54) METHOD FOR DETACHING WAFERS FROM A WAFER CARRIER AND DEVICE FOR THIS PURPOSE

(75) Inventors: Jorg Lampprecht, Dornham (DE); Dirk Plaueln, Dornstetten (DE); Gerhard Wolber, (US); Lechen Wolber, Balersbronn-Huzenbach (DE); Michael Wolber, Balersbronn-Schwarzenberg (DE); Hans-Jorg Wolber, Seewald-Gottelfingen (DE)

(73) Assignee: Gebr. Schmid GmbH & Co., Freudenstadt (DE)

(21) Appl. No.: 13/088,118

(22) Filed: Apr. 15, 2011

Related U.S. Application Data
(63) Continuation of application No. PCT/EP2009/063292, filed on Oct. 12, 2009.

(30) Foreign Application Priority Data
Oct. 15, 2008 (DE) 10 2008 053 598.2

(51) Int. Cl. B23P 19/02

(52) U.S. Cl. 29/426.4; 29/700

(57) ABSTRACT

In a method for detaching wafers from a carrier unit, the wafers being formed by sawing a wafer block fastened to the carrier unit by gluing, and the wafers themselves still being glued on one side, the carrier unit with the wafers is introduced into an ungluing unit along a uniform movement plane. It remains therein and is enclosed in an ungluing basin by movable wall parts. Solvent for ungluing is applied into the ungluing basin and onto the wafers after the formation and closing of the ungluing basin to dissolve the glued bond and subsequently detach the wafers from the carrier unit.

### CROSS-REFERENCE TO RELATED APPLICATIONS

This application is a continuation of PCT Application No. PCT/EP2009/063292, filed Oct. 12, 2009, and claims priority to DE 10 2008 053 598.2 filed Oct. 15, 2008, the disclosures of which are hereby incorporated by reference in their entirety.

### FIELD OF USE AND PRIOR ART

The invention relates to a method for detaching wafers from a carrier unit and/or a so-called beam fastened to a carrier unit, the wafers being formed by sawing a wafer block glued to the carrier unit and/or the beam and still being glued on one side to the carrier unit. The invention also relates to a device for performing this method.

Gluing a wafer block to a beam and then fastening this beam to a carrier unit is known from DE 10 2008 028 213 A. The wafer block can then be transported for further processing using the carrier unit. In particular, the wafer block is sawn into individual thin wafers, the upper edge of the wafers still being glued to the beam. After cleaning of the wafers, they are detached from the beam for singulation and further processing, the adhesive then being able to be dissolved by solvent.

For such an ungluing procedure, the wafers are typically transported with the carrier unit to an ungluing basin and then plunged downward therein. A vertical movement of the wafers is thus used, namely the plunging procedure into the ungluing basin by lowering. This vertical movement of the wafers on the carrier unit is viewed as disadvantageous, because it represents a mechanical strain.

### OBJECT AND ACHIEVEMENT

The invention is based on the object of providing a method cited at the beginning and a device cited at the beginning for performing the method, using which disadvantages of the prior art may be remedied and a lower mechanical strain of the wafers can be achieved in particular.

This object is achieved by a method having the features of Claim 1 and a device having the features of Claim 14. Advantageous and preferred embodiments of the invention are the subject matter of the further claims and are explained in greater detail hereafter. The wording of the claims is incorporated in the content of the description by express reference. Some of the features listed hereafter are described only for the method or only for the device, but they are to be applicable independently to both the method and also the device.

It is provided that the individual thin wafers formed by sawing the wafer block are still glued to the beam and/or fastened to the carrier unit, the beam also being held on the carrier unit. Above all, the wafers are still glued on at one side and/or side edge. According to the invention, the wafers are introduced into an ungluing unit, in which they remain for the ungluing, on the carrier unit jointly therewith along a uniform movement plane and/or in a uniform movement plane. They are enclosed using movable wall parts in the ungluing unit, an ungluing basin being formed below and laterally adjacent to the carrier unit and/or adjacent to the wafers using these movable wall parts, in certain circumstances together with fixed wall parts. After the formation and/or closing of the ungluing basin, solvent is introduced for the ungluing, advantageously decanted into the ungluing basin, particularly advantageously from below, so that the wafers are first immersed in the liquid for a softer detachment. Alternatively, solvent can be sprayed onto the area in which the wafers are still glued on. This solvent is used for the purpose of dissolving the adhesive and thus ungluing the wafers, so that they may then be detached and/or removed from the carrier unit. For example, acetic acid is used as the solvent, or alternatively other solvents matching with the adhesive.

Thus, in an advantageous embodiment variant of the invention, the carrier unit is moved with the wafers in a uniform movement plane, so that no vertical acceleration forces act thereon. The ungluing basin is more or less provided and/or constructed around the wafers and closed. After the ungluing, the ungluing basin is again opened or disassembled and the wafers are moved further and/or moved away in a uniform movement plane. Means are advantageously provided on the carrier unit in order to still hold the detached wafers, which are no longer glued in place, and/or prevent falling down with possible danger of damage. This will be discussed in greater detail hereafter.

In an advantageous embodiment of the invention, the wafers are moved on the carrier unit along a primary movement direction into the ungluing unit. After the ungluing, they are moved further and/or transported further in this movement direction. As previously described, the wafers also advantageously remain in the same movement plane during the ungluing. This movement plane is particularly advantageously horizontal, which allows a simple construction of such an in-line cleaning device and/or facility. For the most careful possible handling of the wafers, it can be provided that the wafers with the carrier unit not only are not moved vertically or horizontally during the ungluing, but rather remain immobile as much as possible as a whole. Mechanical strains may thus also be reduced and/or avoided.

The ungluing basin, in which the ungluing of the wafers is to occur, can have movable side wall parts, at least at the location or on the side where the wafers with the carrier unit are moved in the movement direction. A corresponding side wall part can be moved away to the side or upward, in order to expose the ungluing basin and/or to allow the carrier unit with wafers to be moved into the correct position for ungluing. The ungluing basin having the movable side wall parts can then be closed again. The ungluing basin is advantageously terminated on top, for example by a glass cover. The side parts, preferably the movable side wall parts above all, are implemented in sealing fashion and/or are provided with seals and held on a frame, for example.

In an advantageous embodiment of the invention, it is provided that the carrier unit with wafers is transported lying on a roller conveyor. The carrier unit is particularly advantageously constructed as described in DE 10 2008 053 596 A, the content of which in this respect is incorporated in the content of the description by express reference. Such a carrier unit can simply be laid on the roller conveyor and then be moved on and with the rollers, the wafers still only being fastened using by their glued-on side edge.

The two movable side wall parts pointing in the movement direction may advantageously be moved synchronously together. For this purpose, for example, a single mechanically coupled drive can be provided. In a further embodiment of the invention, it is possible that when the wafers are moved into the ungluing basin and when they are moved out, only the side wall part respectively standing in the way is moved away, or advantageously this side wall part is moved together with the corresponding side wall part on the other side. A drive mechanism can thus be kept comparatively simple with good functionality. The other two side wall parts are advantageously also implemented as movable, but they do not have to be moved away and/or lifted each time, but rather only for maintenance or inspection work, for example. Furthermore, a base of the ungluing basin, against which the side wall parts press in sealing fashion to close the ungluing basin, can be rigid and/or immobile. Advantageously, openable flaps or drains may be provided thereon, using which the solvent can be drained, so that uncontrolled solvent outflow does not occur when the side wall parts are moved away.

To introduce the solvent into the ungluing basin and/or to apply it to the wafers, on the one hand, it can simply be introduced into the closed ungluing basin so that the basin is filled up until the adhesive is reached, advantageously from below. Alternatively, the solvent can be sprayed directly onto the wafers. The duration of the wetting of the glued bond of the wafers with the solvent is then increased in order to improve the dissolving effect. It can be provided that the solvent is collected by closing the ungluing basin and/or also rises far enough that the glued bond is immersed in the solvent.

In another embodiment of the invention, it can be provided that the carrier unit with wafers is unglued and/or moved into the ungluing basin and the entire ungluing unit so that the wafers do not hang fixed and/or are not glued to the carrier unit by their upper side edge, but rather by a lower side edge. The wafers then more or less stand on the glued side edge. This has the advantage that after ungluing and/or dissolving of the adhesive, no movement or slipping of the wafers occurs, rather they remain standing on the same side edge. This also additionally reduces the mechanical strain and danger of damage.

In yet another embodiment of the invention, it is possible to keep the wafers at approximately equal spacing to one another during the application of the solvent and/or during the ungluing. For this purpose, they are advantageously held on the carrier unit and/or retention means running laterally along the carrier unit may be provided for this purpose. These retention means may run on at least two opposing side edges of the wafers and engage thereon. An example of such retention means is a rod brush, as is known from DE 10 2005 028 112 A, to which reference is made in this regard and the content of which is incorporated in the present description by express reference.

In another embodiment of the invention, two ungluing units may be provided one after another to increase the throughput through the device. The ungluing procedure can thus be performed more or less in two steps. In a first step and/or a first ungluing unit, essentially only solvent is applied to the wafers, and then they are moved further to the next step and/or into the next ungluing unit having a separate ungluing basin. Small residual quantities of solvent may remain on the wafers after the first ungluing basin. The solvent should not drip off from the wafers in relatively large quantities, rather it can essentially be provided that a flushing and/or cleaning method is omitted. In the second ungluing unit, solvent can then be applied again and act until the wafers are completely unglued and/or detached from the carrier unit.

In a further embodiment of the invention, it is possible to influence the ungluing through the temperature of the solvent and/or the ungluing. In particular, a method temperature above room temperature can be used, for example above 50° C. Possible, cooling of the wafers can then be provided after the ungluing through the cleaning carried out in any case, for example using cool cleaning liquid. Water is advantageously used for this purpose, using which the wafers are flushed.

These and further features are disclosed in the claims and also in the description and the drawings, the individual features being able to be implemented alone or in multiples in the form of subcombinations in an embodiment of the invention and in other fields and being able to represent advantageous embodiments which can be protected per se, for which protection is claimed here. The division of the application into individual sections and sub-headings does not restrict the statements made thereunder in their general validity.

### BRIEF DESCRIPTION OF THE DRAWINGS

Exemplary embodiments of the invention are schematically shown in the drawings and are explained in greater detail hereafter. In the figures of the drawings:

FIG. 1 shows a side view of an entire device for processing wafers with cleaning and ungluing of the wafers,

FIG. 2 shows a side view of an open ungluing basin, and

FIG. 3 shows a perspective oblique view of the ungluing basin from FIG. 2.

### DETAILED DESCRIPTION OF THE EXEMPLARY EMBODIMENTS

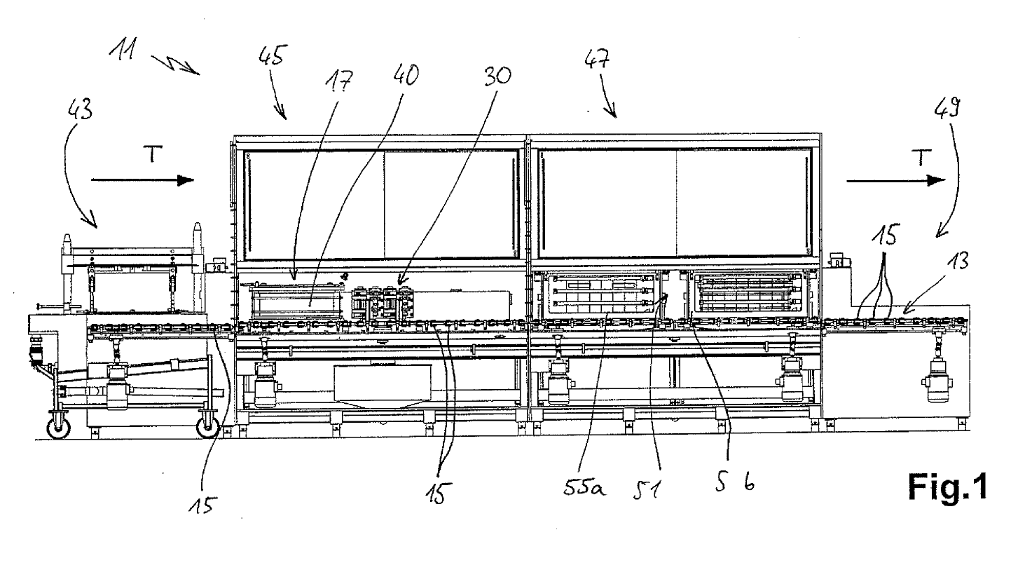

FIG. 1 shows a side view of an entire device 11 according to the invention, in which not only the cleaning of a sawn wafer block 40 occurs, but rather above all also the ungluing according to the invention, i.e. the detachment of the individual sawn wafers from the beam and/or the longitudinal carrier of the carrier units 17, to which they are still glued. The device 11 advantageously has chambers enclosing them. On the far left, it has an insertion module 43, using which the cage-like carrier units 17 with wafer blocks 40 therein are brought to the device 11 and then introduced. It can be seen that the insertion module 43 has rollers 15, which form a roller conveyor at the height of the transport conveyor 13 with the other rollers 15. The rollers are advantageously driven individually or as a whole. The previously described uniformly horizontal transport of the wafer blocks 40 can thus also be performed here.

A cleaning module 45 is implemented, as can be recognized and is easily imaginable, as a type of closed or closable chamber having nozzle units 30 therein. This cleaning module 45 and the carrier unit are described extensively in DE 10 2008 053 596 A, the content of which in this respect is incorporated in the content of the present description by express reference.

The arrow T shows the main movement direction of the carrier unit 17 with wafer block 40 through the device 11. This means that the carrier unit 17 with wafers therein is moved on the transport conveyor 13 and/or the rollers 15.

The ungluing module 47 adjoins the cleaning module 45 directly on the right in the movement direction T. The ungluing module 47 has a similar chamber-like construction and again has the transport conveyor 13 having rollers 15. Furthermore, the ungluing module 47 has an ungluing chamber 51 having two ungluing basins 55a and 55b, which are situated one behind another in the movement direction T and are also approached one after another by a carrier unit 17 with sawn wafer block 40. The ungluing basins 55a and 55b may be implemented essentially identically and are accessible through movable, in particular raisable, side wall parts in the movement direction T.

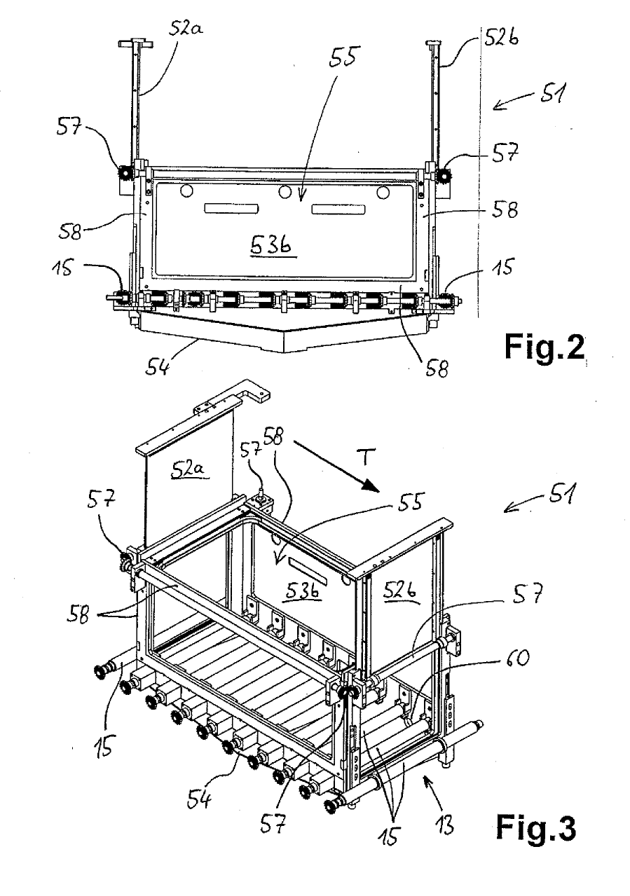

It is shown more clearly in FIGS. 2 and 3 how the ungluing basins 55 are constructed in detail in the ungluing chamber 51. An ungluing basin has an essentially oblong rectangular shape having two short side wall parts 52a and 52b, which are situated above the transport conveyor 13. Long side wall parts 53a and 53b are provided on the long sides. The ungluing basin 55 is closed on the bottom in sealing fashion by a base 54. The side wall parts may be fastened to a frame 58 of the ungluing basin 55. The long side wall parts 53a and 53b may have openings, through which nozzles or spray units for the solvent may project or at least spray.

The short side wall parts 52a and 52b are movable upward to open and close the ungluing basin 55, and they are mounted in sealing fashion. A drive 57 is provided for this purpose, which comprises multiple parts, the two side wall parts 52a and 52b being moved synchronously.

The long side wall parts 53a and 53b may also be removed; however, no movement unit is provided for this purpose. However, they are advantageously welded for more stability and better sealing function. A drain 60 is shown in the base 54 on the bottom right below the rear long side wall part 53b, using which solvent can be drained out of the ungluing basin 55. This drain 60 advantageously has a corresponding closure. Furthermore, multiple such drains may be provided, for example at least one inlet and optionally an overflow.

The ungluing basin 55 is terminated on the bottom by the base 54. The latter runs clearly visibly below the rollers 55. It can be implemented as slightly V-shaped downward, so that contaminants and/or the solvent in general may be removed better from the ungluing basin 55.

A carrier unit 17 with wafer block 40 is thus moved into an ungluing basin 55, the basin is then closed, and the ungluing procedure then begins, as was previously described. A cycle time for the ungluing can be approximately 15 minutes, for example. If this is inadequate for a desired throughput in spite of the two ungluing basins 55a and 55b, multiple such ungluing modules 47 are to be provided adjacent to one another or one behind another. The two ungluing basins advantageously operate independently of one another.

After the ungluing and/or the ungluing module 47 having the two ungluing basins 55a and 55b, the carrier unit 17 having the unglued wafers is moved out to an exit module 49. This module also has the rollers 15 of the trans-port conveyor 13. From there, the carrier unit 17 having the individual wafers can be moved further, for example into a unit known per se, in which the wafers are singulated and/or are removed individually from the wafer stack formed, for further handling and processing.

1. A method for detaching wafers from a carrier unit, said wafers being formed by sawing a wafer block fastened to said carrier unit by gluing, and said wafers themselves still being glued to said carrier unit on one side, said carrier unit with said wafers being introduced into an ungluing unit along a uniform movement plane and remaining therein and being enclosed in said ungluing unit by movable wall parts, an ungluing basin being formed using fixed and movable wall parts below and laterally adjacent to said carrier unit and said wafers, wherein solvent for said ungluing step is applied into said ungluing basin and onto said wafers after said formation and said closing of said ungluing basin to dissolve said glued bond and subsequently detach said wafers from said carrier unit.

2. The method according to claim 1, wherein said wafers are moved on said carrier unit along a primary movement direction into said ungluing unit and are moved back out again in said movement direction and transported further after said ungluing.

3. The method according to claim 2, wherein said wafers remain in a movement plane of said movement direction during said ungluing.

4. The method according to claim 1, wherein said carrier unit with said wafers is not moved in said horizontal direction or along said movement direction during said ungluing.

5. The method according to claim 1, wherein said ungluing basin has movable side wall parts on said sides pointing in said movement direction, wherein at least said side wall part pointing toward said approaching wafer block is moved away to expose said ungluing basin for introduction of said carrier unit with said wafers, wherein subsequently said ungluing basin is closed using said side wall parts.

6. The method according to claim 5, wherein both said movable side wall parts pointing in said movement direction are moved synchronously.

7. The method according to claim 1, wherein said carrier unit with said wafers is moved resting on a transport conveyor.

8. The method according to claim 1, wherein solvent is decanted into said closed ungluing basin, in which said carrier unit with said wafers is located, by filling from below, said solvent collecting in said closed basin.

9. The method according to claim 1, wherein said wafers are moved into said ungluing basin for ungluing so that said glued side edges lie on a bottom and point downward.

10. The method according to claim 1, wherein said wafers are kept at approximately equal spacing to one another during application of said solvent and during said ungluing.

11. The method according to claim 10, wherein said wafers are held by retention means running laterally along said carrier unit, said retention means engaging on at least two opposing side edges of said wafers.

12. The method according to claim 1, wherein two said ungluing units are provided one after another to increase throughput, essentially only said solvent being applied to said wafers in a first ungluing unit, and remaining on said wafers in residual quantities, wherein said wafers then are moved into said second ungluing unit for renewed application of said solvent until said wafers are completely unglued from said carrier unit.

13. The method according to claim 1, wherein flushing of said wafers with cleaning liquid is performed after said ungluing in said second ungluing unit.

14. A device for performing the method according to claim 1, wherein said device has a transport conveyor for said carrier unit with said wafers and at least one said ungluing unit having an ungluing basin, said ungluing basin having a movable side wall part for opening said ungluing basin for introduction of said carrier unit with said wafers on at least one side toward a direction from which said carrier unit with said wafers is moved thereto.

15. The device according to claim 14, wherein said ungluing basin has an oblong extension in direction of said movement direction of said carrier unit with said wafers.

16. The device according to claim 14, wherein application devices are provided on said side wall parts in order to apply or spray water laterally onto said wafers.

17. The device according to claim 14, wherein two said ungluing basins are provided one after another in said movement direction of said carrier unit with said wafers.
